(19) United States
(12) Patent Application Publication
(10) Pub. No.: US 2008/0105123 A1
(43) Pub. Date: May 8, 2008

(54) GAS TURBINE AIR FILTER

(75) Inventor: Robert Henry Devine, Raytown, MO (US)

Correspondence Address: SUTHERLAND ASBILL & BRENNAN LLP, 999 PEACHTREE STREET, N.E., ATLANTA, GA, 30309, US

(73) Assignee: General Electric Company, Schenectady, NY (US)

(21) Appl. No.: 11/555,737

(22) Filed: Nov. 2, 2006

(51) Int. Cl. B01D 46/52

(52) U.S. Cl. 95/273; 55/491

(57) ABSTRACT

An air filter. The air filter may include a frame made of a beverage board material, a filter media with a number of pleats, and one or more stiffener bands. The stiffener bands may include a number of teeth sized to mate with at least one of the pleats.

### TECHNICAL FIELD

The present application relates generally to gas turbines and more particularly relates to an air filter for use in high moisture gas turbine environments.

### BACKGROUND OF THE INVENTION

A gas turbine generally is operated with one or more air filters upstream of an intake duct or housing for the air compressor or other components. The air filter includes a filter frame to support the internal filter media. Inexpensive filter frames may be made out of beverage board or similar types of materials. In humid or moist environments, however, the filter media and frame can become saturated during use. As a result, the filter material is generally held within a plastic or metal frame so as to support the increased weight of the saturated material. Alternatively, the entire filter assembly of the frame and the filter media may be discarded. Such metal or plastic frames, however, generally are not combustible or easily recyclable. Moreover, such metal or plastic frames certainly are more expensive than known beverage board frames.

There is a desire therefore, for an improved gas turbine inlet air filter that can accommodate moisture and humid conditions. Preferably, the air filter as a whole is easy to install, use, costs less than existing plastic or metal filter frames, and may be recyclable and/or reusable in whole or in part.

### SUMMARY OF THE INVENTION

The present application describes an air filter. The air filter may include a frame made of a beverage board material, a filter media with a number of pleats, and one or more stiffener bands. The stiffener bands may include a number of teeth sized to mate with at least one of the pleats.

The filter media may include fiberglass and/or paper. The beverage board material may be coated paperboard. The beverage board material and the filter media may be recyclable. The stiffener bands may be plastic or metal. The air filter further may include one or more perimeter stiffener bands. The perimeter stiffener bands may surround the frame in whole or in part. The perimeter stiffener bands may be made out of plastic or metal.

The present application further describes a method of using an air filter with a gas turbine. The method may include the steps of installing a filter media within a beverage board frame, positioning the beverage board frame with the filter media therein upstream of the turbine, supporting the filter media within the beverage board frame via one or more stiffener bands, and filtering particulates and moisture from air flowing through the media to the gas turbine. The supporting step further may include supporting the beverage board frame via one or more perimeter stiffener bands.

The present application further describes air filter for use with a gas turbine. The air filter may include a frame made of a beverage board material, a filter media with a number of pleats, one or more stiffener bands, and one or more perimeter stiffener bands that surround the frame in whole or in part. The stiffener bands may include a number of teeth sized to mate with the pleats.

The filter media may be made out of fiberglass and/or paper. The beverage board material may be made out of coated paperboard. The beverage board material and the filter media may be recyclable. The stiffener bands and the perimeter stiffener bands may be made out of plastic or metal.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of an air filter as is described herein.

FIG. 2 is a plan view the teeth of a frame of the air filter of FIG. 1.

FIG. 3 is a perspective view of the air filter of FIG. 1 positioned about a gas turbine air inlet housing.

FIG. 4 shows an alternative embodiment of the frame of the air filter as is described herein.

FIG. 5 shows an alternative embodiment of the frame of the air filter of FIG. 4.

FIG. 6 shows an alternative embodiment of the frame of the air filter of FIG. 4.

### DETAILED DESCRIPTION

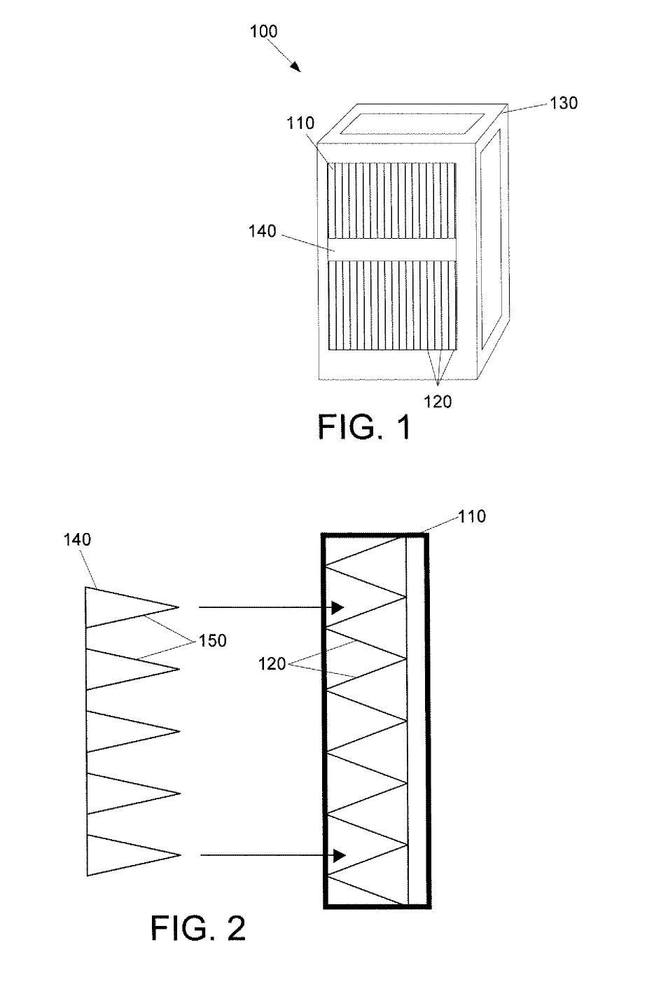

Referring now to the drawings in which like numerals indicate like elements throughout the several views, FIG. 1 shows an air filter 100 as is described herein. Although the use of the air filter 100 will be described in the context of a gas turbine, the air filter 100 is equally applicable to other uses. Any number of air filters 100 may be used. The air filter 100 removes particulates and moisture from the air flowing upstream of the gas turbine.

The air filter 100 includes a filter media 110. The filter media 110 generally may be fiberglass, paper (synthetic or blends), mixtures thereof, and similar types of filtering materials. Any suitable type of material may he used herein. The filter media 110 may have any desired size or shape. In this example, the filter media 110 may include a number of pleats 120 formed therein. The pleats 120 provide a relatively large filtering area so as to provide a lower pressure drop and adequate air flow capacity.

The air filter 100 further may include a frame 130. The frame 130 encloses and supports the filter media 1 10. The frame 130 may be made out of a beverage board material. The term “beverage board” describes coated cardboard or paperboard generally used in the beverage industry for bottles or cans. The beverage board material is coated so as to resist absorbing moisture. The term “beverage board” also includes other types of materials such as corrugated cardboard and similar types of relatively light weight and thin but substantially rigid materials. The material of the frame 130 may be die cut from a continuous sheet of the beverage board material and constructed by folding the various flaps and panels and then joining the flaps and panels together via an adhesive or otherwise. Various types of carton making devices are known in the art and may be used herein. The frame 130 may have any desire size or shape.

The air filter 100 also may include one or more stiffener bands 140. The stiffener bands 140 may extend across one or both of the open faces of the frame 130. The stiffener bands 140 may be made out of conventional plastics or metals or similar types of materials. Because the stiffener bands 140 are used largely in ambient conditions, the bands 140 do not need to be resistant to extremely high temperatures. The stiffener bands 140 may include a number of teeth 150. FIG. 2 shows the insertion of a stiffener band 140 within the pleats 120 of the filter media 110. The teeth 150 may be sized and shaped to fit within the pleats 120 of the filter media. Any number of teeth 150 may be used herein. The stiffener bands 140 thus serve to strengthen the air filter 100 as a whole. The stiffener band 140 may be perforated or porous to permit air flow therethrough.

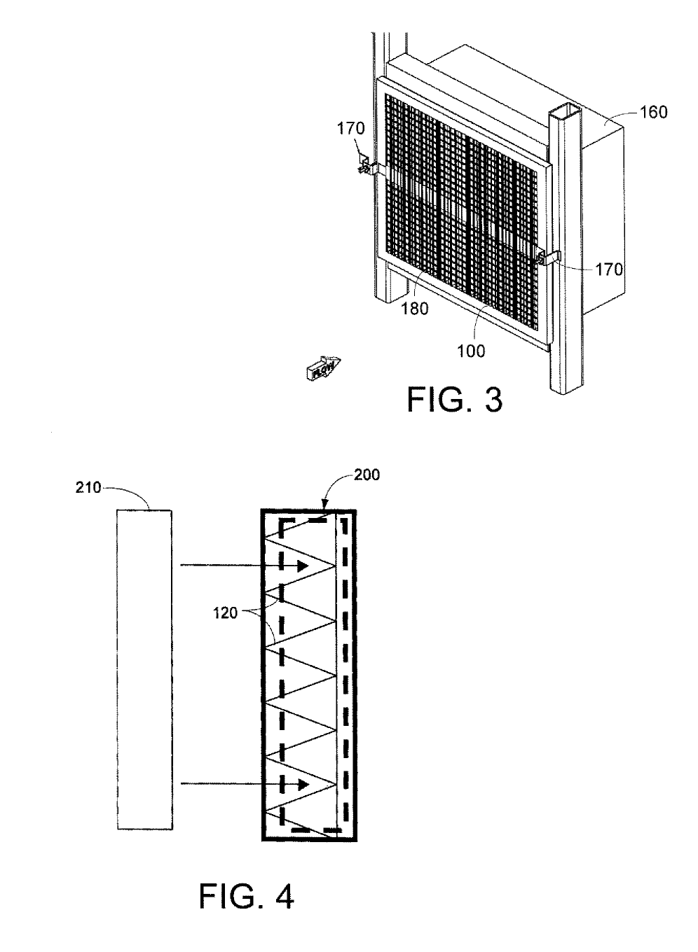

In use, the air filter 100 may be positioned about an air inlet or housing 160 of a gas turbine or otherwise. The air filter 100 may be mounted to the air housing 160 in a conventional fashion. Specifically, the frame 130 may be mounted to the air housing via retention clips 170 or similar types of connection means as is shown in FIG. 3. The air filter 100 traps moisture and particulate matter in a conventional fashion. A screen 180 also may be mounted in front of the air filter 100 to trap larger matter. As the filter media 110 becomes moist and/or saturated, the combination of the frame 130 and the stiffener bands 140 support the filter media 110 so as to keep the filter media 110 in place and operational. Likewise, the teeth 150 of the stiffener bands 140 keep the pleats 120 separated so as to keep the air filter 100 as a whole functional. Moisture generally drips away from the frame 130 given the use of the coated paperboard that makes up the beverage board.

When the filter media 110 is saturated or due for replacement the filter media 110 may be removed from the frame 130. The filter media 110 then may be discarded or recycled in a conventional fashion. A new filter media 110 may be installed within the frame 130. The frame 130 also may be removed from the air housing 160 or the frame 130 may remain in place when replacing the filter media 110. The frame 130 may need to be replaced at some point. The material of the frame 130, however, is reusable. The frame 130 also has much lower cost as compared to plastic and metal frames given the use of the beverage board material or similar materials. The air filter 100 described herein thus provides the user with a great amount of flexibility in choosing and replacing air filters.

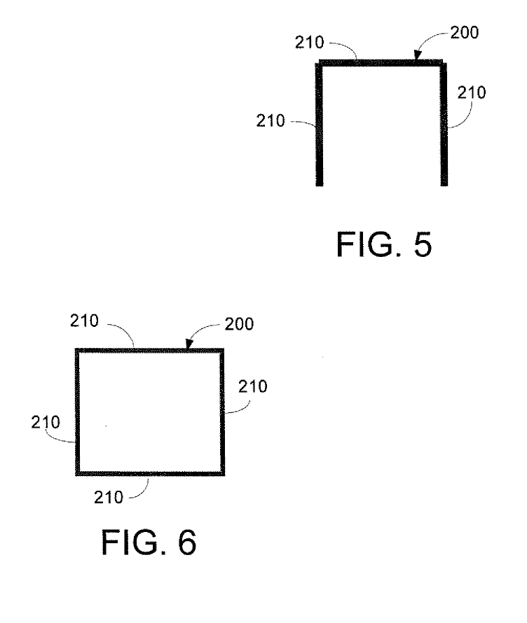

FIGS. 4-6 show a further embodiment as is described herein of an air filter 200. The air filter 200 is identical to the air filter 100 described above, but with the addition of one or more perimeter stiffener bands 210. The perimeter stiffener bands 210 may be made out of the same material as the stiffener bands 140 described above. As is shown in FIG. 5 the perimeter stiffener bands 210 may be placed on some of the sides of the frame 130 or around all of the sides of the frame 130 as shown in FIG. 6. The perimeter stiffener bands 210 may be positioned about the periphery of the frame 130 or otherwise. The perimeter stiffener bands 210 also aid in holding the shape of the frame 130 and supporting the filter media 110 therein.

It should be apparent that the foregoing relates only to the preferred embodiments of the present application and that numerous changes and modifications may be made herein by one of ordinary skill in the art without departing from the general spirit and scope of the invention as defined by the following claims and the equivalents thereof.

I claim:

1. An air filter, comprising:
a frame;
wherein the frame comprises a beverage board material;
a filter media;
wherein the filter media comprises a plurality of pleats; and
one or more stiffener bands;
wherein the one or more stiffener bands comprise a plurality of teeth sized to mate with at least one of the plurality of pleats.

2. The air filter of claim 1, wherein the filter media comprises fiberglass and/or paper.

3. The air filter of claim 1, wherein the beverage board material comprises coated paperboard.

4. The air filter of claim 1, wherein the beverage board material comprises a reusable material.

5. The air filter of claim 1, wherein the filter media comprises a recyclable material.

6. The air filter of claim 1, wherein the one or more stiffener bands comprise plastic or metal.

7. The air filter of claim 1, further comprising one or more perimeter stiffener bands.

8. The air filter of claim 7, wherein the one or more perimeter stiffener bands surround the frame in whole or in part.

9. The air filter of claim 7, wherein the one or more perimeter stiffener bands comprise plastic or metal.

10. A method of using an air filter with a gas turbine, comprising:
installing a filter media within a beverage board frame;
positioning the beverage board frame with the filter media therein upstream of the turbine;
supporting the filter media within the beverage board frame via one or more stiffener bands; and
filtering particulates and moisture from air flowing through the filter media to the gas turbine.

11. The method of claim 10, wherein the supporting step further comprises supporting the beverage board frame via one or more perimeter stiffener bands.

12. An air filter for use with a gas turbine, comprising:
a frame;
wherein the frame comprises a beverage board material;
a filter media;
wherein the filter media comprises a plurality of pleats;
one or more stiffener bands;
wherein the one or more stiffener bands comprise a plurality of teeth sized to mate with the plurality of pleats; and
one or more perimeter stiffener bands;
wherein the one or more perimeter stiffener bands surround the frame in whole or in part.

13. The air filter of claim 12, wherein the filter media comprises fiberglass and/or paper.

14. The air filter of claim 12, wherein the beverage board material comprises coated paperboard.

15. The air filter of claim 12, wherein the beverage board material comprises a reusable material.

16. The air filter of claim 12, wherein the filter media comprises a recyclable material.

17. The air filter of claim 12, wherein the one or more stiffener bands comprise plastic or metal.

18. The air filter of claim 12, wherein the one or more perimeter stiffener bands comprise plastic or metal.
